(19) United States
(12) Patent Application Publication
(10) Pub. No.: US 2005/0213881 A1
(43) Pub. Date: Sep. 29, 2005

(54) Device for automatic centering of a laser beam and method for making same

(76) Inventors: Pascal Leclerc, Massy (FR); Jose Garcia, Neuilly Plaisance (FR)

Correspondence Address: Robert E Krebs;Thelen Krebs & Priest, P O Box 640640, San Jose, CA, 95164-0640, US

(21) Appl. No.: 10/519,015

(22) PCT Filed: Jun. 25, 2003
(86) PCT No.: PCT/FR03/01963

§ 371 Date: Dec. 21, 2004

(30) Foreign Application Priority Data
Jun. 27, 2002 (FR) 02/08010

(51) Int. Cl. G02B 6/26

(52) U.S. Cl. 385/31

(57) ABSTRACT

Device for automatically centring a laser beam in a light guide and method of manufacturing this device.

This device comprises a volume scatterer (2) to scatter a laser beam and automatically centring it in a light guide (32), for example a monomode or multimode optical fibre. To manufacture the device, a tubular light guide (6) is manufactured and the volume scatterer is made from a material scattering light, using the tubular light guide as a cutting punch.

### TECHNICAL DOMAIN

This invention relates to a device for automatically centring a laser beam, particularly in a monomode optical fibre or in a multimode optical fibre, after the said beam has been misaligned or off centred.

This device is applicable more particularly to laser beams for which misalignments or off centrings are greater than or are similar to the transverse dimensions of the optical fibres.

The invention also relates to a method of manufacturing this device.

### STATE OF PRIOR ART

Known centring devices may be classified into two categories:
static devices, tolerating alignment and centring variations for injection of the laser beam into a fibre, and
dynamic devices, tolerating alignment and centring variations and provided with a system for recentring the laser beam with respect to the fibre entry, either by deviating this laser beam or by orienting the fibre.

Static devices mainly use surface light scatterers, more simply referred to as surface scatterers, in other words means with a surface capable of scattering light of the incident light beam, but do not make it possible to obtain sufficient uniformities for injections into the fibres, due to:
firstly, the initial non-uniformity of the laser beam which is only partially corrected, and
secondly, the coherence of this laser beam.

Indeed, when a surface scattering object is illuminated by a laser, the points that make up this object scatter a coherent light and produce a Fresnel type speckle in the entire space surrounding them.

As for dynamic devices, they have the major disadvantage that they require advanced knowledge of alignment and off centring variations to correct the position of the optical fibre with respect to the laser beam.

Therefore, they are generally only applicable to recurrent lasers because they require several laser pulses to converge towards the optimum coupling position.

This type of device uses electronic means that are slaved from a CCD type sensor or a four-quadrant sensor, this sensor being placed on a position which is the image of the core of the optical fibre.

They control mobile optics that must compensate for alignment variations of the laser beam in order to optimise coupling in the fibre.

The advantage of this type of device is that they can give high coupling ratios (of the order of 50%). However, they are very expensive due to their complexity and require very fine alignments sensitive to temperature variations and vibrations.

This constraint is due to the small size of the fibre core and its small angular aperture, which require optics with a relatively high focal length (typically of the order of 20 cm) for which the positioning must be of the order of 1 μm.

### PRESENTATION OF THE INVENTION

The purpose of the invention is to overcome the above-mentioned disadvantages.

To achieve this, a static centring device is used comprising a volume light scatterer, more simply called a volume scatterer, in other words a means for which the volume—and no longer the surface—is capable of scattering light of the incident laser beam that is to be centred.

Specifically, the purpose of this invention is a device for automatically centring a laser beam in a light guide, this device being characterised in that it comprises a volume scatterer comprising an entry face for the laser beam and designed to scatter this laser beam and automatically centre it in the light guide.

This light guide may be a monomode optical fibre or a multimode optical fibre.

According to one preferred embodiment of the device according to the invention, the thickness of the volume scatterer is equal to at least 100 times the wavelength of the laser beam.

The volume scatterer may be made of polytetrafluorethylene.

According to one particular embodiment of the device according to the invention, the volume scatterer is cylindrical.

Preferably, the volume scatterer comprises a side face and the device also comprises a light reflector that surrounds this side face.

According to a first preferred embodiment of the device according to the invention, this device also comprises a lens placed on the entry face of the volume scatterer and designed to defocus the light beam on this entry face.

According to a second preferred embodiment, the volume scatterer comprises a side face and the device also comprises a light reflector that surrounds this side face, is prolonged beyond the entry face and guides the light beam as far as this entry face.

According to a third preferred embodiment, the device according to the invention also comprises an auxiliary optical fibre that is optically coupled to the entry face of the volume scatterer and guides the light beam as far as this entry face.

This invention also relates to a method of manufacturing the device according to the invention, in which a tubular light guide is manufactured and the volume scatterer is made from a material capable of scattering light, using the tubular light guide as a cutting punch.

### BRIEF DESCRIPTION OF THE DRAWINGS

This invention will be better understood after reading the description of example embodiments given below for information purposes only and that are in no way limitative, with reference to the appended figures, wherein:

FIG. 1 diagrammatically illustrates an example of a volume scatterer that can be used in this invention,

FIG. 2 is a diagrammatic sectional view of a first particular embodiment of the device according to the invention,

FIG. 3 is a diagrammatic sectional view of a second particular embodiment of the device according to the invention,

FIG. 4 is a diagrammatic sectional view of a third particular embodiment of the device according to the invention,

FIG. 5 is a diagrammatic sectional view of a fourth particular embodiment of the device according to the invention,

FIG. 6A diagrammatically illustrates a step for manufacturing a device according to the invention,

FIG. 6B is a diagrammatical sectional view of a device according to the invention,

FIG. 7 diagrammatically illustrates scattering of light by an elementary volume of scattering material, and

FIG. 8 shows curves of the variation of scattered illumination and the reduced incident illumination as a function of the distance.

### DETAILED PRESENTATION OF PARTICULAR EMBODIMENTS

As mentioned above, the device according to the invention is used to correct the disadvantages of prior art, firstly because it is static and secondly because it uses a volume scatterer. In this case, the coherence of the laser beam and therefore the resulting speckle can be reduced.

Using media with non-homogeneities that are small in comparison with the size of the beam, multiple scatterings introduce random phase relations between the different points of the beam and degrade spatial coherence.

The volume scatterer is made from an adapted material in order to obtain correct uniformities. The choice of this material is made as a function of the optical scattering coefficient that must be as large as possible, and the absorption coefficient that must be as small as possible.

In this respect, refer to the end of the description that contains a radiation transfer theory.

A material such as polytetrafluorethylene or Teflon (registered trademark) is well adapted to laser beams for visible and near infrared spectra.

It has also been found that a device according to the invention does not degrade the shape of a pulse laser beam in time, provided that the duration of the pulses is not less than 10⁻¹¹ s, and that the coherence of the beam does not reduce the uniformity of this beam at the outlet from the scatterer, due to superposition of decorrelated speckle figures.

A volume scatterer is also used; this means that the length L, or the thickness, of this scatterer is significant compared with the wavelength of the incident laser beam F that is to be centred (FIG. 1). Preferably, the thickness of this scatterer is equal to at least 100 times this wavelength.

Advantageously, this volume scatterer is cylindrical with a length that depends on the uniformity and the required global transmission.

This is diagrammatically illustrated in FIG. 1, which shows a device according to the invention comprising a cylindrical volume scatterer 2 made of Teflon (registered trademark) with length L.

A laser beam F is focused on one end 4 of the scatterer 2 forming an entry face. The laser light is scattered in the form of spherical waves S at the exit from the scatterer, on the side opposite the entry face 4.

Furthermore, the increase in uniformity at the exit from the scatterer 2 and the increase in the global transmission are obtained by placing the volume scatterer in a reflecting wave guide.

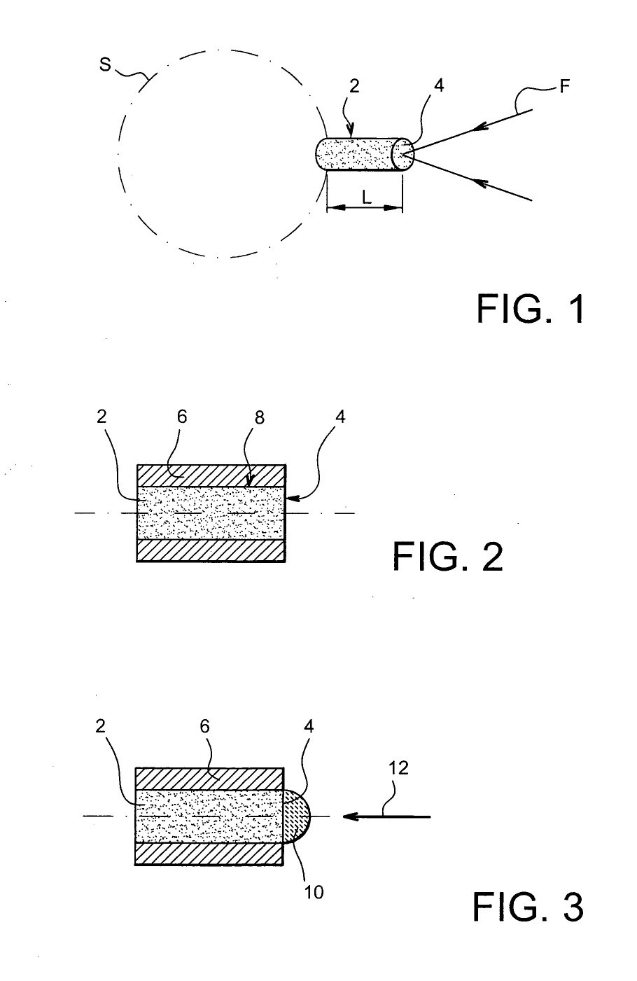

This is diagrammatically illustrated in FIG. 2, which shows the scatterer 2 inserted in a metallic tubular reflector 6 that thus surrounds the side face 8 of the scatterer 2.

This reflector 6 or guide reflects the laser light that reaches this side face 8 and thus guides this light in the scatterer 2.

An empirical formula, that is experimentally verified, makes it possible to make a simple calculation of the global transmission and to size the centring device with respect to the misalignment to be corrected.

This formula gives the transmission T of the device provided with a metallic guide, and is as follows:

$$T = {ⅇ}^{- r s} z \frac{{}_{p} a {sin}^{2} α}{4 A}$$

In this formula:
A is the metallic guide section (in m²),
a is the section (in m²) of the optical fibre that is coupled to the scatterer and in which the laser beam is to be centred,
α is the numerical aperture angle of the fibre,
z is the guide length (in m),
ρ is the density of particles that scatter light (number per m³), and
σ is the scattering cross section (in m²).

Auxiliary means may advantageously be added to the reflecting guide to increase the resistance of the automatic centring device under flux.

Indeed if the laser beam is focused on the entry face of the scatterer, there is a risk of damaging it.

According to a first possibility, the risks of degradation can be reduced by adding a micro-lens in front of the scatterer to defocus the laser beam on the entry face of the scatterer, in other words so that the laser beam is not focused on this entry face.

This is diagrammatically illustrated in FIG. 3 that shows a micro-lens 10 placed in contact with the entry face 4 of the scatterer 2. This micro-lens 10 is capable of defocusing the incident laser beam 12 on the face 4 of the scatterer, the scatterer and the micro-lens 10 being coaxial.

In the example in FIG. 3, the diameter of the micro-lens is equal to the diameter of the scatterer 2.

According to a second possibility, the laser beam is guided as far as the scatterer by extending the wave guide towards the front of the scatterer, and the geometric extent of the beam is increased by increasing its surface at the scatterer, which reduces the risks of degrading this scatterer.

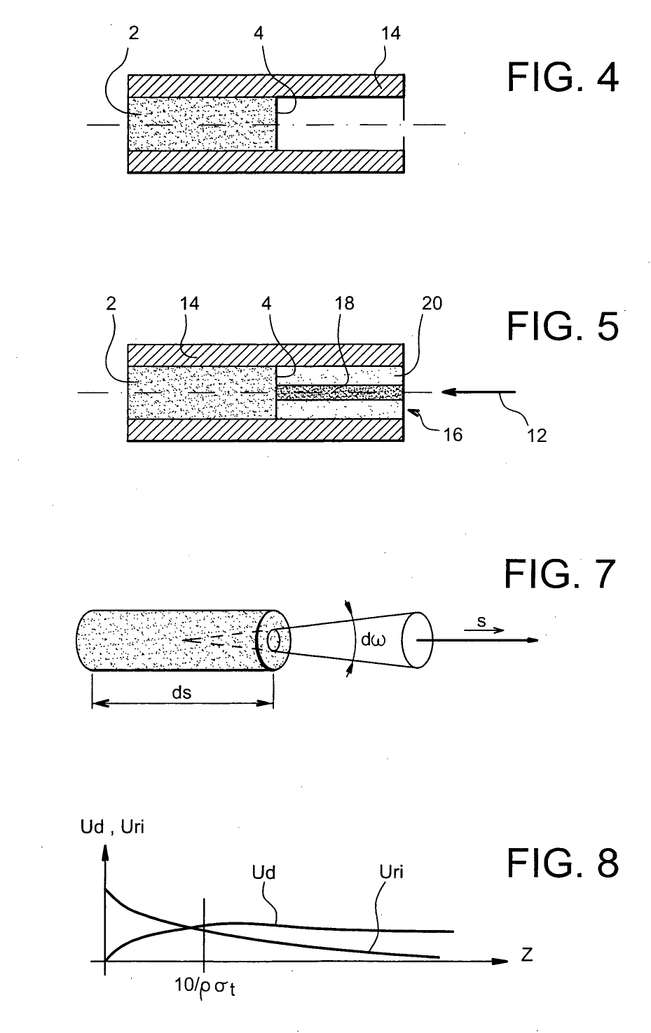

This is diagrammatically illustrated in FIG. 4, which shows a tubular reflector 14 that surrounds the cylindrical scatterer 2 and projects beyond the entry face 4 of this scatterer.

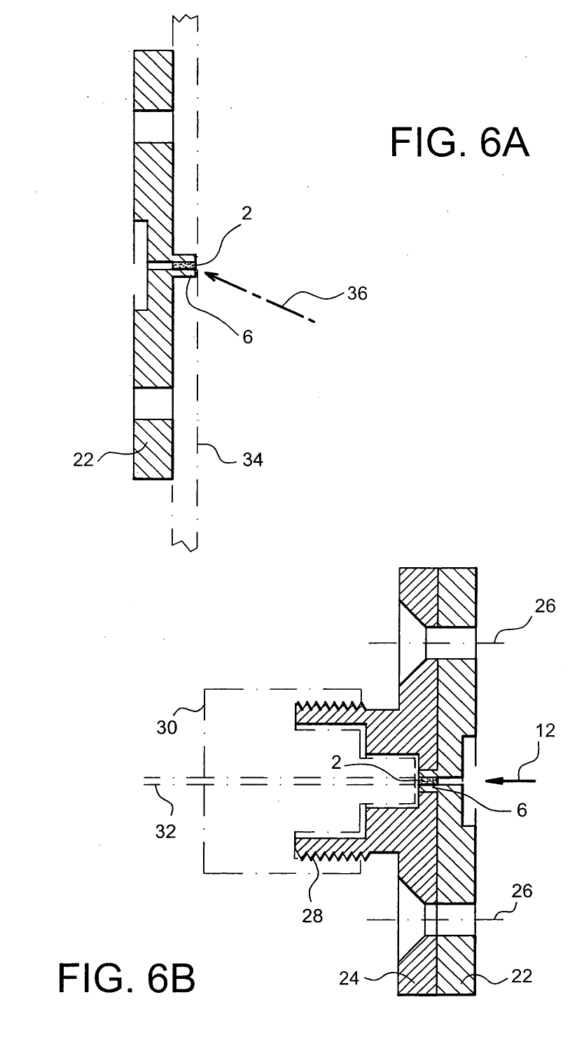

In the description in FIG. 6A, a method of manufacturing the scatterer 2 in FIG. 2 in a tubular reflector with the same length will be explained.

The scatterer in FIG. 4 may be obtained in the same way, in a longer tubular reflector and then by pushing the scatterer towards the side of the reflector opposite the side through which the scattering material was introduced.

According to a third possibility, a large diameter optical fibre is added in front of the volume scatterer to increase the resistance under flux of the automatic centring device.

This is diagrammatically illustrated in FIG. 5. In this example, a segment of optical fibre 16 in which the core and the cladding are marked with references 18 and 20 respectively, is added to the device in FIG. 4. The core 18 and the scatterer 2 are coaxial.

The segment 16, for which the diameter is approximately equal to the diameter of the scatterer 2, is housed in the part of the guide 14 that projects beyond the entry face 4. This entry face is in contact with the fibre segment 16.

The fibre segment 16 thus receives the laser beam 12 before the scatterer, which avoids hot points in the scatterer.

The reflecting guide 6 may advantageously be used as a cutting punch to make the scatterer from a flexible scattering material (if the guide is made from a sufficiently hard material).

This is diagrammatically illustrated by the example in FIG. 6A showing the tubular guide 6, for example made of steel, that is rigidly fixed to a steel plate 22, thus forming a projection from this plate 22.

As can be seen in FIG. 6B, this plate 22 is engaged by means of this projection into a support 24 and is fixed to the support by screws, symbolically represented by chained dotted lines 26.

The support 24 comprises a threaded part 28 on which an optical fibre connector 30 can be screwed. It is thus possible to optically connect the scatterer 2 to the optical fibre 32 provided on this connector 30, the plate 22 and the support 24 being suitably perforated for this purpose.

In particular, as can be seen in FIG. 6B, the drilling of the plate 22 is such that the scatterer 2 is located in a reflector of the type shown in FIG. 4, rather than in a guide of the type shown in FIG. 2.

The device in FIG. 6B enables centring of the laser beam 12 on the optical fibre 32 due to the volume scatterer 2.

This device is manufactured using a plate 34 made of a flexible scattering material, for example a Teflon plate (registered trademark), and the plate 22 made of steel is applied in contact with this plate 34 (FIG. 6A).

The projection formed by the tubular guide 6 in FIG. 6A penetrates into the material and a part of this material penetrates into the tubular guide to form the scatterer 2.

An appropriate cutting tool 36 is then used to separate the scatterer thus formed from the rest of the material.

For guidance only and in no way limitatively, a Teflon scatterer (registered trademark) with a length (thickness) equal to 750 μm, which is nearly 700 times the wavelength of the laser beam, and a polished steel wave guide projecting from the scatterer by 0.3 mm on the side on which the laser beam enters, are used to centre a laser beam with a wavelength of 1064 nm.

This invention is not limited to centring of a laser beam in an optical fibre (single mode or multimode).

It is also applicable to centring of a laser beam in other light guides, for example planar guides.

We will now describe the radiation transfer theory, in other words transfer of light by the scatterer.

In the case of a straight propagation, the variation dL of luminance L (in W/m²/sr) when crossing a thickness dz of an elementary volume is such that:

$$\frac{ⅆ L}{ⅆ z} = - ( a + b ) L$$

where α is the absorption coefficient (in m⁻¹) and β the scattering coefficient (in m⁻¹).

In the case of scattering particles, for which the scattering cross section σₛ, the absorption cross section σₐ and the extinction cross section σₜ=σₐ+σₛ (in m²) are defined, the incident luminance I(r, \vec{s}) is similarly expressed at point r in the direction \vec{s}, on an elementary cylindrical volume with length ds (see FIG. 7) as follows:

$$\frac{ⅆ I ( r , \vec{s} )}{ⅆ s} = ρ {σ}_{t} I ( r , \vec{s} )$$

where ρ is the volume density of particles.

All scatterings and absorptions originating from all directions \vec{s}′ have to be added to the term defining absorption and scattering along direction \vec{s}. They are expressed starting from the particles scattering phase function ρ(\vec{s}, \vec{s}′) that is defined by:

$$\frac{1}{4 π} {\int }_{4 π}^{} ρ ( \vec{s} , {\vec{s} }^{′} ) ⅆ ω = {W}_{0} = \frac{{σ}_{s}}{{σ}_{t}}$$

where W₀ is the albedo of a single particle and dω is the elementary solid angle.

A term (in W/m³/sr) also has to be added corresponding to emission of the elementary volume with length ds in the direction \vec{s}, and denoted ε(r, \vec{s}).

All these contributions can be integrated to obtain a transfer equation:

$$\frac{ⅆ I ( r , \vec{s} )}{ⅆ s} = - ρ {σ}_{t} I ( r , \vec{s} ) + \frac{ρ {σ}_{t}}{4 π} {\int }_{4 π}^{} ρ ( \vec{s} , {\vec{s} }^{′} ) I ( r , {\vec{s} }^{′} ) ⅆ {ω}^{′} + ɛ ( r , \vec{s} )$$

The total luminance I in the direction \vec{s} at point r is dissociated into two terms corresponding to the reduced incident luminance Iᵣᵢ and the scattered luminance I_{d}. The following two equations are obtained:

$$\frac{ⅆ {I}_{r i}}{ⅆ s} ( r , \vec{s} ) = - ρ σ t I r i ( r , \vec{s} )$$

$$\frac{ⅆ {I}_{d}}{ⅆ s} ( r , \vec{s} ) = - ρ {σ}_{t} I d ( r , \vec{s} ) \\ = \frac{ρ {σ}_{t}}{4 π} {\int }_{4 π}^{} ρ ( \vec{s} , {\vec{s} }^{′} ) {I}_{d} ( r , {\vec{s} }^{′} ) ⅆ {ω}^{′} + ɛ ( r , \vec{s} ) + {ɛ}_{r i} ( r , \vec{s} )$$

$$where ɛ r i ( r , \overline{s} ) = \frac{ρ {σ}_{t}}{4 π} {\int }_{4 π}^{} ρ ( \vec{s} , {\vec{s} }^{′} ) {I}_{r i} ( r , {\vec{s} }^{′} ) ⅆ {ω}^{′}$$

The illumination U_{d} and flux vector F_{d} scattered at point r are derived therefrom:

$$U d ( r ) = \frac{1}{4 π} {\int }_{4 π}^{} I ( r , \vec{s} ) ⅆ ω and F d ( r , \vec{s} ) = \frac{1}{4 π} {\int }_{4 π}^{} I ( r , \vec{s} ) \vec{s} ⅆ ω$$

If a collimated or Gaussian beam arrives on a plane sample, the scattered illumination U_{d}(r) can be calculated at all points. To achieve this, Green functions G(r,r′) have to be introduced that satisfy the propagation equation and the boundary conditions for a plane sample with length d:

$$\begin{matrix}{∇}^{2} G ( r , {r}^{′} ) - {}^{{κ}_{d}^{2}} G ( r , {r}^{′} ) = - δ ( r , {r}^{′} ) \\ G ( r , {r}^{′} ) - {h}^{\frac{\partial }{\partial z}} G ( r , {r}^{′} ) = 0 z = 0 \\ G ( r , {r}^{′} ) + {h}^{\frac{\partial }{\partial z}} G ( r , {r}^{′} ) = 0 z = d\end{matrix}$$

In these equations,
h=2ρσtr/3 and Kd=3ρσtrρσa
where σₜᵣσₐ+σₛ(1−μ) and μ is the cosine of the average scattering angle.

The scattered illumination at a point r is then expressed as follows:

$$U d ( r ) = {\int }_{V}^{} G ( r , {r}^{′} ) Q ( {r}^{′} ) ⅆ {V}^{′} + {\int }_{S}^{} \frac{G ( r , {r}^{′} ) {Q}_{1} ( {r}^{′} )}{2 π h} ⅆ {S}^{′}$$

where

$$Q ( \vec{r} ) = Q ( r , θ , z ) = 3 ρ σ t {r}^{\frac{{P}_{0}}{π {w}^{2}}} exp ( - ρ σ t z ) {exp}^{( \frac{- 2 {r}^{2}}{{w}^{2}} )} ,$$

where Q₁(\vec{r}) is zero for isotropic scattering, dV is the volume of the sample, Pₒ is the incident power of the laser beam and W is the radius at 1/e² of the laser beam.

It is possible to analytically express the scattered illumination U_{d} using modified Bessel functions and it can be calculated for different values of ρ, σₜ and sample thickness.

Various simulations were carried out that give variations of U_{d} and Uᵣᵢ (reduced incident illumination) as a function of the particle density and the extinction cross section for three thicknesses of the sample (0.5 mm, 1 mm and 2 mm).

The power of the laser used was 1 mW and the numerical aperture was 0.11.

FIG. 8 shows curves of the variation of U_{d} and Uᵣᵢ as a function of z.

The reduced incident illumination Uᵣᵢ decreases as a function of exp(−ρσₜz) and the dimension of the laser beam, while the scattered illumination U_{d} increases firstly as a function of z and then decreases.

With the chosen configuration that is related to the entry laser beam, the product ρσₜz must be of the order of 10 so that U_{d} is of the order of Uᵣᵢ.

The order of magnitude of this value can be found by simple considerations. The reduced incident illumination decreases in the following form:

$${U}_{ri} ( z ) = K1 \times \frac{exp ( - {}_{rs}^{}{t}{}_{}^{z} )}{{}_{q} {2 \; 2}_{z}}$$

where K1 is a proportionality constant and θ is the aperture angle at 1/e² of the laser beam in the material, while we can write the following for the scattered illumination, due to the conservation of energy, and assuming that this illumination is constant over a sphere of radius z:
   4πz²Ud(z)=K2x(1−exp(−ρσtz))
   where K2 is a proportionality constant.

When U_{d} is equal to Uᵣᵢ, exp(−ρσₜz) is not very different from

$$\frac{{θ}^{2}}{4 π}$$

and therefore ρσₜz is not very different from 7.

The order of magnitude mentioned above is obtained once again.

1. Device for automatically centring a laser beam in a light guide (32), this device being characterised in that it comprises a volume scatterer (2) comprising an entry face for the laser beam and designed to scatter this laser beam and automatically centre it in the light guide.

2. Device for automatically centring a laser beam in a monomode or multimode optical fibre (32), this device being characterised in that it comprises a volume scatterer (2) comprising an entry face for the laser beam and designed to scatter this laser beam and automatically centre it in the optical fibre.

3. Device according to claim 1, in which the thickness (L) of the volume scatterer (2) is equal to at least 100 times the wavelength of the laser beam.

4. Device according to claim 1, in which the volume scatterer (2) is made of polytetrafluorethylene.

5. Device according to claim 1, in which the volume scatterer (2) is cylindrical.

6. Device according to claim 1, in which the volume scatterer (2) comprises a side face and the device also comprises a light reflector (6, 14) that surrounds this side face.

7. Device according to claim 1, also comprising a lens (10) placed on the entry face of the volume scatterer (2) and designed to defocus the light beam on this entry face.

8. Device according to claim 1, in which the volume scatterer (2) comprises a side face and the device also comprises a light reflector (14) that surrounds this side face, and is prolonged beyond the entry face and guides the light beam as far as this entry face.

9. Device according to claim 1, also comprising an auxiliary optical fibre (16) that is optically coupled to the entry face of the volume scatterer (2) and guides the light beam as far as this entry face.

10. Method of manufacturing the device according to claim 1, in which a tubular light guide (6) is manufactured and the volume scatterer (2) is made from a material (34) capable of scattering light, using the tubular light guide as a cutting punch.

11. Device according to claim 2, in which the thickness (L) of the volume scatterer (2) is equal to at least 100 times the wavelength of the laser beam.

12. Device according to claim 2, in which the volume scatterer (2) is made of polytetrafluorethylene.

13. Device according to claim 2, in which the volume scatterer (2) is cylindrical.

14. Device according to claim 2, in which the volume scatterer (2) comprises a side face and the device also comprises a light reflector (6, 14) that surrounds this side face.

15. Device according to claim 2, also comprising a lens (10) placed on the entry face of the volume scatterer (2) and designed to defocus the light beam on this entry face.

16. Device according to claim 2, in which the volume scatterer (2) comprises a side face and the device also comprises a light reflector (14) that surrounds this side face, and is prolonged beyond the entry face and guides the light beam as far as this entry face.

17. Device according to claim 2, also comprising an auxiliary optical fibre (16) that is optically coupled to the entry face of the volume scatterer (2) and guides the light beam as far as this entry face.

18. Method of manufacturing the device according to claim 2, in which a tubular light guide (6) is manufactured and the volume scatterer (2) is made from a material (34) capable of scattering light, using the tubular light guide as a cutting punch.
